(19) United States
(12) Patent Application Publication
(10) Pub. No.: US 2002/0060534 A1
(43) Pub. Date: May 23, 2002

(54) Inline self-convergence type deflection yoke including compensating inductor

(75) Inventor: Koji Nakajima, Shiga (JP)

Correspondence Address: SUGHRUE, MION, ZINN,MACPEAK & SEAS, 2100 Pennsylvania Avenue, N.W., Washington, DC, 20037, US

(73) Assignee: NEC CORPORATION

(21) Appl. No.: 09/989,661

(22) Filed: Nov. 21, 2001

(30) Foreign Application Priority Data
Nov. 22, 2000 (JP) 2000-355082

(51) Int. Cl. G09G 1/04

(52) U.S. Cl. 315/364

(57) ABSTRACT

In an inline self-convergence type deflection yoke for use in a three-gun color Braun tubes a pair of main vertical deflection windings and a pair of auxiliary vertical deflection windings are connected in series between a vertical deflection current input terminal and a vertical current output terminal. A differential resistor is connected in parallel with the pair of the auxiliary vertical deflection windings and has a movable end. An inductor is connected between the movable end and a connection point of the auxiliary vertical deflection windings.

### BACKGROUND OF THE INVENTION

1. Field of the Invention

The present invention relates to an inline self-convergence type deflection yoke for use in a three-gun color Braun tube (cathode ray tube), and more particularly, to the improvement of misconvergence of red and blue electron beams.

2. Description of the Related Art

Generally, in a three-gun color Braun tube, three-color electron guns, i.e., a red (R) color electron gun, a green (G) color electron gun and a blue (B) color electron gun are arranged in a line along a horizontal line, i.e., an X-direction. In order to converge electron beams emitted from the electron guns, inline self-convergence type deflection yokes have been adopted.

A first prior art inline self-convergence type deflection yoke is constructed by a horizontal deflection circuit formed by two horizontal deflection windings connected in series for generating a pin-shaped magnetic field and a vertical deflection circuit formed by two vertical deflection windings connected in series for generating a barrel-shaped magnetic field. Three electron beams emitted from the three color guns are converged by the pin-shaped magnetic field and the barrel-shaped magnetic field into predetermined locations of a fluorescent screen through a shadow mask. In this case, however, misconvergence may occur between the electron beams of the guns due to the distortion of the magnetic fields, the displacement of the electron beam, and the like. This will be explained later in detail.

In order to compensate for the misconvergence in the Y-direction, a second prior art inline self-convergence type deflection yoke includes a compensation circuit constructed by a pair of auxiliary vertical deflection windings connected in series between the vertical deflection windings and a differential resistor (or variable resistor) connected in parallel with the series of the auxiliary Vertical deflection windings. The differential resistor has a movable end connected via a resistor to a connection point of the auxiliary vertical deflection windings.

Thus, the misconvergence in the Y-direction can be compensated for by adjusting the location of the movable end of the differential resistor. This also will be explained later in detail.

In order to compensate for the misconvergence in the X-direction, a third prior art inline self-convergence type, deflection yoke includes another compensation circuit constructed by an additional differential resistor (or variable resistor) connected in parallel with the series of the vertical deflection windings. The additional differential resistor has a movable end connected via a resistor to a connection point of the vertical deflection windings.

Thus, the misconvergence in the X-direction can be compensated for by adjusting the location of the movable end of the additional differential resistor. This also will be explained later in detail.

As the frequency of three-gun color Braun tubes has recently been increased, even in the above-described second and third inline self-convergence type deflection yokes, misconvergences still occur due to the difference in phase between the currents flowing the auxiliary windings or the vertical windings. This will be explained later in detail.

### SUMMARY OF THE INVENTION

It is an object of the present invention to provide an inline self-convergence type deflection yoke for use in a three-gun color Braun tube capable of extinguishing misconvergences due to the difference in phase between currents flowing through windings.

According to the present invention, in an inline self-convergence type deflection yoke for use in a three-gun color Braun tube, a pair of main vertical deflection windings and a pair of auxiliary vertical deflection windings are connected in series between a vertical deflection current input terminal and a vertical current output terminal. A first differential resistor is connected in parallel with the pair of the auxiliary vertical deflection windings and has a first movable end. A first inductor is connected between the first movable end and a connection point of the auxiliary vertical deflection windings.

Also, a second differential resistor is connected in parallel with the pair of the main vertical deflection windings and has a second movable end, and a second inductor is connected between the second movable end and a connection point of the main vertical deflection windings.

### BRIEF DESCRIPTION OF THE DRAWINGS

The present invention will be more clearly understood from the description set forth below, as compared with the prior art, with reference to the accompanying drawings, wherein:

FIG. 1A is a circuit diagram illustrating a horizontal deflection circuit of a first prior art inline self-convergence type deflection yoke for use in a three-gun color Braun tube;

FIG. 1B is a diagram showing the arrangement of the horizontal windings of FIG. 1A;

FIG. 2A is a circuit diagram illustrating a vertical deflection circuit of the first prior art inline self-convergence type deflection yoke for use in a three-gun color Braun tube;

FIG. 2B is a diagram showing the arrangement of the vertical windings of FIG. 2A;

FIG. 3A and 38 are diagrams showing the misconvergence of the electron beans of the guns R and b of FIGS. 1B and 2B;

FIG. 4 is a circuit diagram illustrating a vertical deflection circuit of a second prior art inline self-convergence type deflection yoke for use in a three-gun color Braun tube;

FIG. 5 is a diagram showing the arrangement of the auxiliary vertical deflection windings of FIG. 4;

FIG. 6 is a circuit diagram for explaining the operation of the vertical deflection circuit of FIG. 4;

FIG. 7 is a diagram showing a change of the pin-shaped magnetic field by the vertical deflection circuit of FIG. 6;

FIG. 8 is a circuit diagram illustrating a vertical deflection circuit of a third prior art inline self-convergence type deflection yoke for use in a three-gun color Braun tube;

FIG. 9A is a circuit diagram for explaining a problem in the compensation circuit of FIG. 4;

FIGS. 9B and 9C are timing diagrams showing the operation of the compensation circuit of FIG. 9A;

FIG. 10 is a diagram showing the misconvergence of the electron beams of the guns R and B caused by the operation of FIGS. 9B and 9C;

FIG. 11A is a circuit diagram for explaining a problem in the compensation circuit of FIG. 4;

FIGS. 11B and 11C are timing diagrams showing the operation of the compensation circuit of FIG. 11A;

FIG. 12 is a diagram showing the misconvergence of the electron beams of the guns R and B caused by the operation of FIGS. 11B and 11C;

FIG. 13A is a circuit diagram for explaining a problem in the compensation circuit of FIG. 8;

FIG. 13B is a diagram showing the misconvergence of the electron beams of the guns R and B caused by the operation of the compensation circuit of FIG. 13A;

FIG. 14A is a circuit diagram for explaining a problem in the compensation circuit of FIG. 8;

FIG. 14B is a diagram showing the misconvergence of the electron beams of the guns R and B caused by the operation of the compensation circuit of FIG. 14A;

FIG. 15 is a circuit diagram illustrating a first embodiment of the vertical deflection circuit of an inline self convergence type for use in a three-gun color Braun tube according to the present invention;

FIGS. 16A and 16B are circuit diagrams for explaining the compensation circuit of FIG. 15;

FIG. 17 is a circuit diagram illustrating a second embodiment of the vertical deflection circuit of an inline self convergence type for use in a three-gun color Braun tube according to the present invention; and

FIGS. 18A and 18B are circuit diagrams for explaining the compensation circuit of FIG. 17.

### DESCRIPTION OF THE PREFERRED EMBODIMENTS

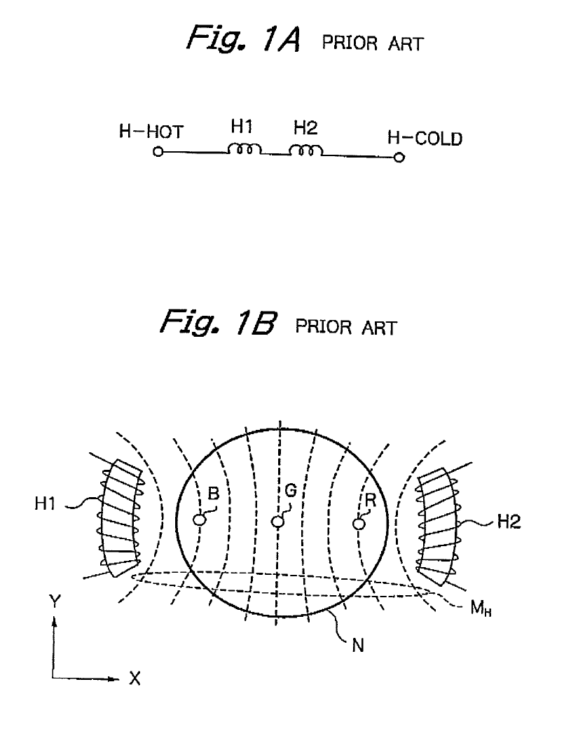

Before the description of the preferred embodiments, prior art inline self-convergence type deflection yokes will be explained with reference to FIGS. 1A, 1B, 2A, 2B, 3A, 3B, 4, 5, 6, 8, 9A, 9B, 9C, 10, 11A, 11B, 11C, 12, 13A, 13B, 14A and 14B.

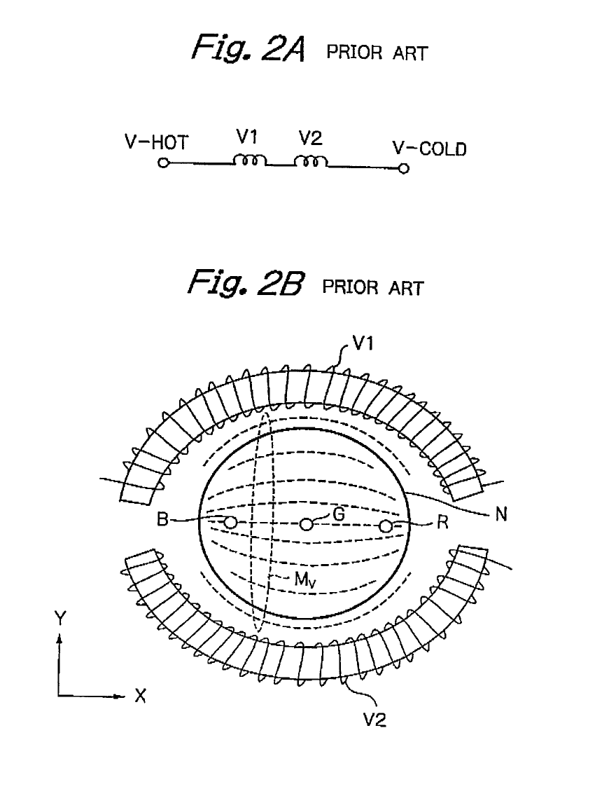

A first prior art inline self-convergence type deflection yoke for use in a three-gun color Braun tube is constructed by a horizontal deflection circuit as illustrated in FIG. 1A and a vertical deflection circuit as illustrated in FIG. 2A.

As illustrated in FIG. 1A, the horizontal deflection circuit is formed by two horizontal deflection windings HI and HZ connected in series between a horizontal deflection current input terminal H-Hot and a horizontal deflection current output terminal H-Cold. As illustrated in FIG. 1B, the horizontal deflection windings H1 and H2 are provided at a neck N of a color Braun tube oppositely with each other in an X-direction where three color guns R, G and B are arranged, so that a pin-shaped magnetic field M_{R} is generated.

On the other hand, as illustrated in FIG. 2A, the vertical deflection circuit is formed by two vertical deflection windings V1 and V2 connected in series between a vertical deflection current input terminal V-Hot and a vertical deflection current output terminal V-Cold. As illustrated in FIG. 2B, the vertical deflection windings V1 and V2 are provided at the neck N of the color Braun tube opposite each other in a Y-direction perpendicular to the X-direction, so that a barrel-shaped magnetic field M_{y} is generated.

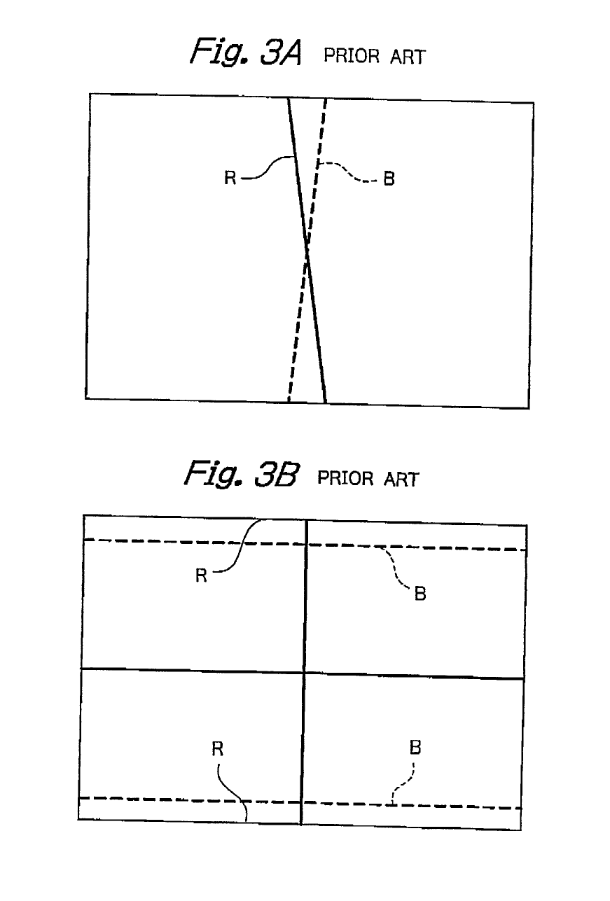

Three electron beams emitted from the three color guns R, G and B are converged by the pin-shaped magnetic field M_{H} and the barrel-shaped magnetic field M_{V} into predetermined locations of a fluorescent screen (not shown) through a shadow mask (not shown). In this case, however, misconvergence as shown in FIGS. 3A and 3B may occur between the electron beams of the guns R and B due to the distortion of the magnetic fields M_{R} and M_{V}, the displacement of the electron beans R and B, and the like. That is, as shown in FIG. 3A, at the center portion of the fluorescent screen, a perpendicular of the electron beam of the gun R is shifted from a perpendicular of the electron beam of the gun B. On the other hand, FIG. 3B, at the upper and lower portions of the fluorescent screen, a horizontal of the electron beam of the gun R is shifted from a horizontal of the electron beam of the gun B. In FIG. 3B, note that the shift of the horizontals of the electron beams of the guns R and B are in the upper portion of the fluorescent screen is symmetrical to that in the lower portion of the fluorescent screen.

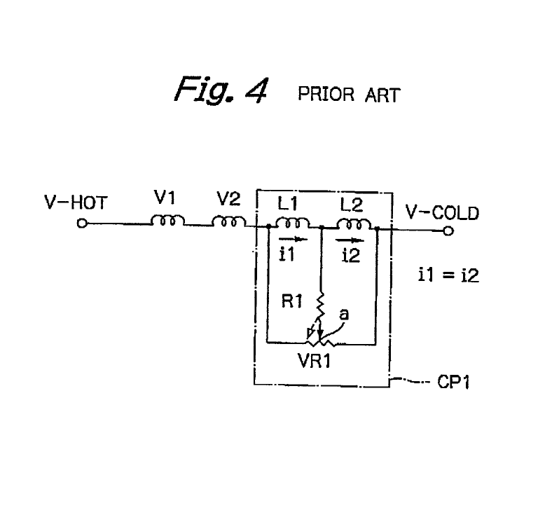

In order to compensate for the misconvergence in the Y-direction as shown in FIG. 3A, a second prior art inline self-convergence type deflection yoke for use in a three-gun color Braun tube is constructed by a vertical deflection circuit as illustrated in FIG. 4. In the vertical deflection circuit of FIG. 4, a compensation circuit CP1 is added to the vertical deflection circuit of FIG. 2A. The compensation circuit CP1 is constructed by a pair of auxiliary vertical deflection windings L1 and L2 connected in series between the vertical deflection winding V2 and the vertical deflection current output terminal V-Cold, and a differential resistor (or variable resistor) VR1 connected in parallel with the series of the auxiliary vertical deflection windings L1 and L2. The differential resistor VR1 has a movable end “a” connected via a resistor R1 to a connection point of the auxiliary vertical deflection windings L1 and L2.

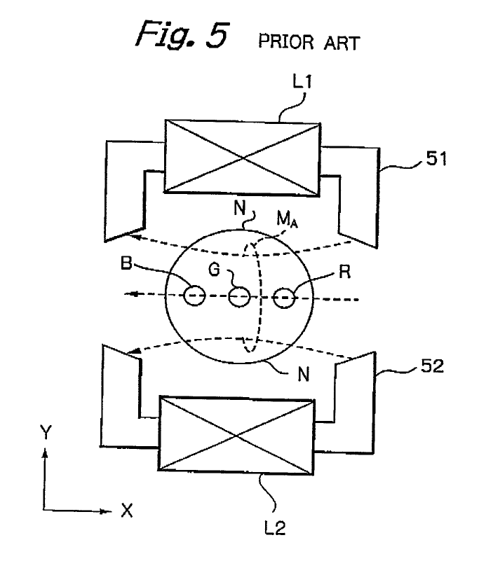

In FIG. 5, which illustrates the arrangement of the auxiliary vertical deflection windings L1 and L2 of FIG. 4, the auxiliary vertical windings L1 and L2 are provided at the neck N opposite each other in the Y-direction. In FIG. 5A, the auxiliary vertical windings L1 and L2 are wound on cores 51 and 52, respectively. In this case, the auxiliary vertical deflection windings L1 and L2 are provided outside of the vertical deflection windings V1 and V2, respectively, or on the downstream side thereof.

If the movable end “a” is located at the center of the differential resistor VR1 as illustrated in FIG. 4, a current i1 flowing through the winding L1 is the same as a current i2 flowing through the winding L2. As a result, as illustrated in FIG. 5, a pin-shaped magnetic field M_{A} generated from the auxiliary vertical detection windings L1 and L2 is symmetrical with respect to the Y-direction.

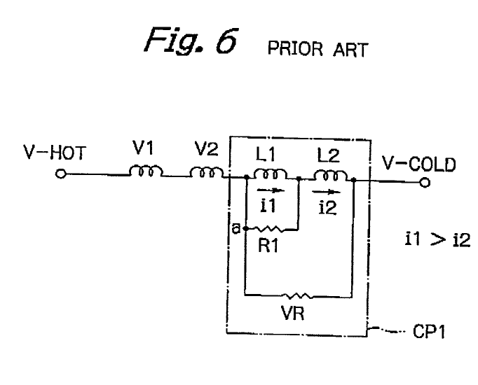

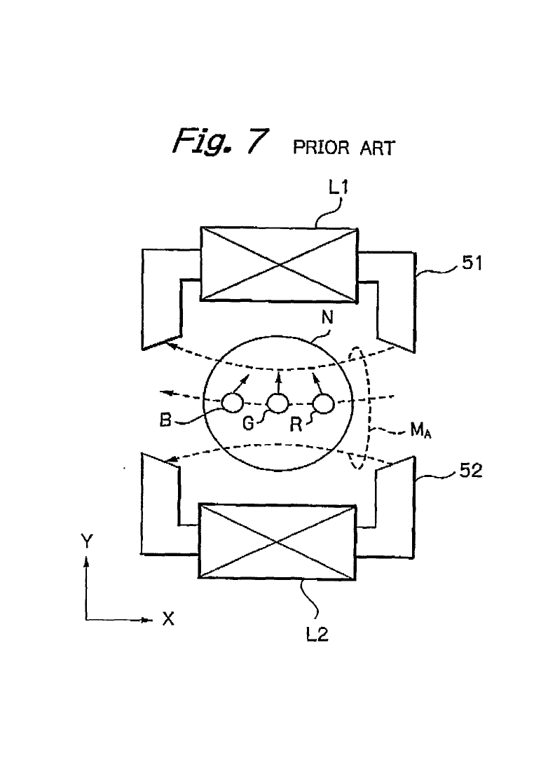

On the other hand, when the movable end “a” is moved at a side location as illustrated in FIG. 6, the current i1 flowing through the winding L1 becomes larger than the current i2 flowing through the winding L2. As a result, a pin-shaped magnetic field M_{A} generated from the auxiliary vertical deflection windings L1 and L2 is asymmetrical with respect to the Y-direction.

Thus, the misconvergence in the Y-direction as shown in FIG. 3A can be compensated for by adjusting the location of the movable end “a” of the differential resistor VR1.

In order to compensate for the misconvergence in the X-direction as shown in FIG. 3B, a third prior art inline self-convergence type deflection yoke for use in a three-gun color Braun tube is constructed by a vertical deflection circuit as illustrated in FIG. 8. In the vertical deflection circuit of FIG. 8, a compensation circuit CP2 is added to the vertical deflection circuit of FIG. 4A. The compensation circuit CP2 is constructed by a differential resistor (or variable resistor) VR2 connected in parallel with the series of the vertical deflection windings V1 and V2. The differential resistor VR2 has a movable end “b” connected via a resistor R2 to a connection point of the vertical deflection windings V1 and V2.

Thus, the misconvergence in the X-direction as shown in FIG. 3B can be compensated for by adjusting the location of the movable end “b” of the differential resistor VR2.

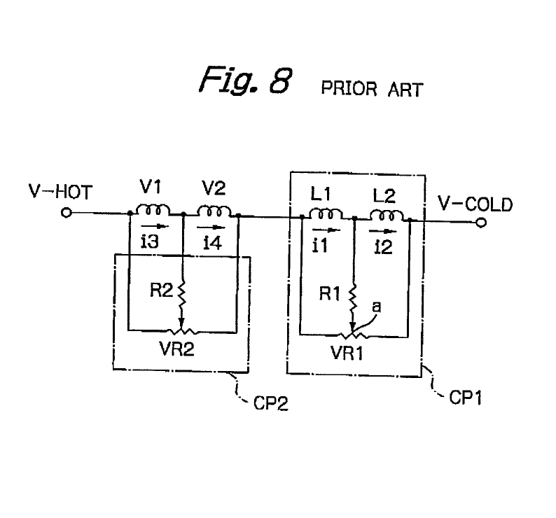

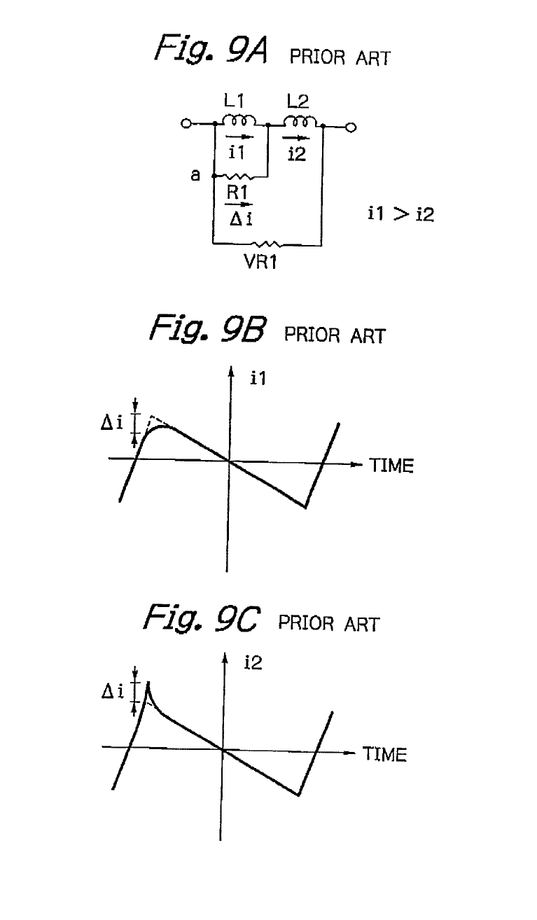

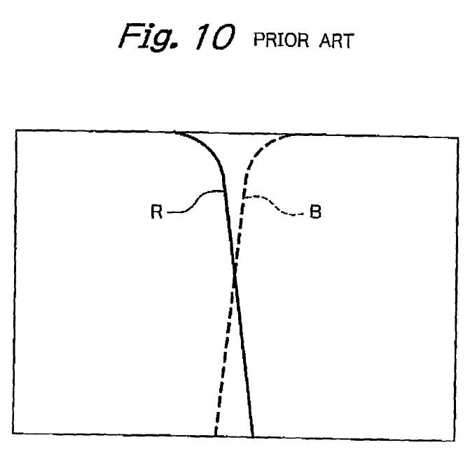

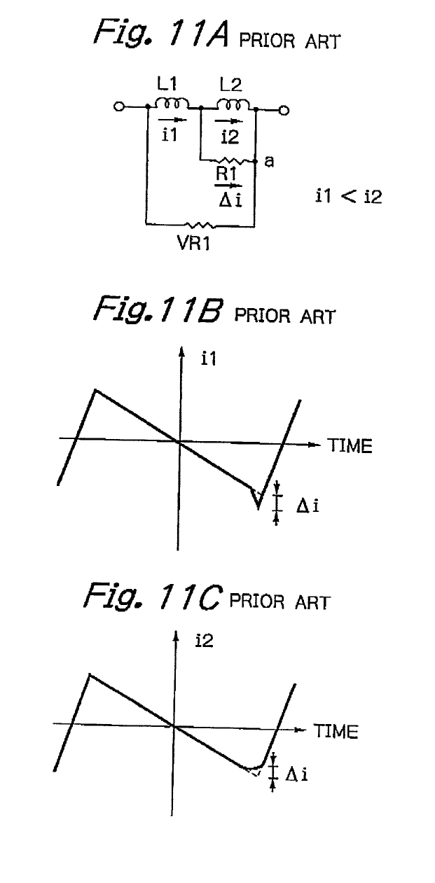

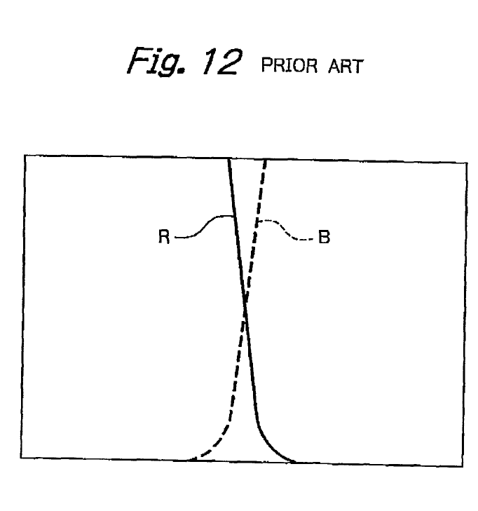

As the frequency of three-gun color Braun tubes has been recently increased, a difference is generated between the increased impedances of the windings L1 and L2, so that a difference in phase may be increased between the currents i1 and i2. Therefore, if the movable end “a” is located as illustrated in FIG. 9A, the current i1 is decreased by Δi as shown in FIG. 9B, while the current i2 is increased by Δi as shown in FIG. 9C. Note that Δi is an increase of the current flowing through the resistor R1 caused by the increased impedance of the winding L1. As a result, the condition of i1>i2 is softened, so that misconvergence between the electron beams of the guns R and B at the upper portion of the fluorescent screen occurs, thus generating a wing-shaped misconvergence as shown in FIG. 10. On the other hand, if the movable end “a” is located as illustrated in FIG. 11A, the current i1 is increased by Δi as shown in FIG. 11B, while the current i2 is decreased by Δi as shown in FIG. 11C. Note that Δi is also an increase of the current flowing through the resistor R1 caused by the increased impedance of the winding L1. As a result, the condition of i1<i2 is softened, so that misconvergence between the electron beans of the guns R and B at the lower portion of the fluorescent screen occurs, thus generating a reverse-wing-shaped misconvergence as shown in FIG. 12.

Note that the current A Δi can be suppressed by increasing the value of the resistor R1; in this case, however, this substantially decreases the dynamic range of the differential resistor VR1.

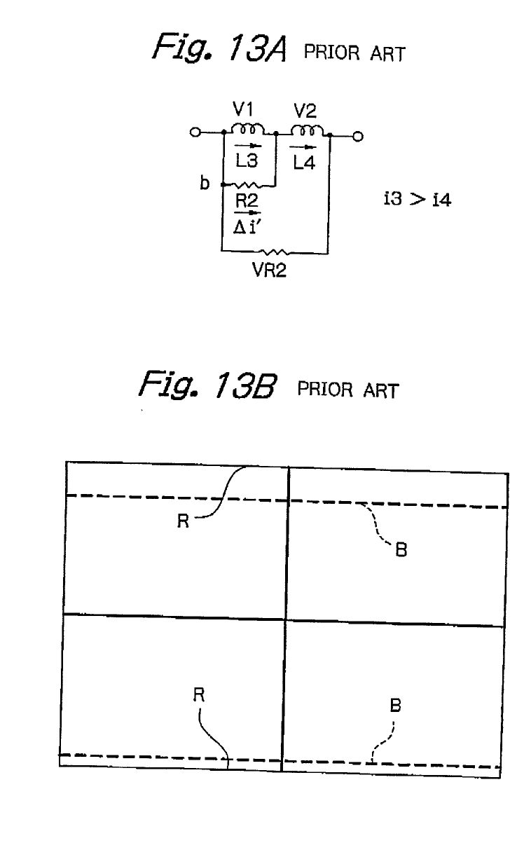

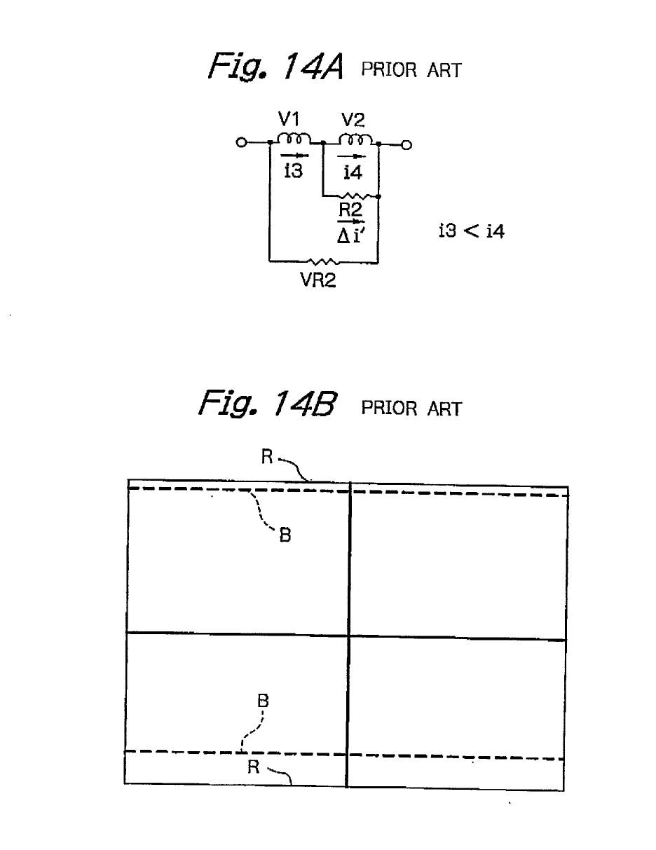

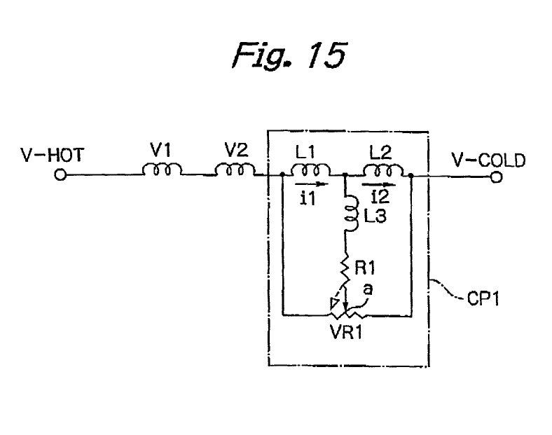

Similarly, a difference is generated between the increased impedances of the windings V1 and V2, so that a difference in phase may be increased between the currents i3 and i4 flowing through the windings V1 and V2, respectively. Therefore, if the movable end “b” is located as illustrated in FIG. 13A, the current i3 is decreased by Δi′, while the current i4 is increased by Δi′. Note that Δi′ is an increase of the current flowing through the resistor R2 caused by the increased impedance of the winding V2. As a result, the condition of i3>i4 is softened, so that asymmetrical misconvergence between the electron beams of the guns R and B at the upper and lower portions of the fluorescent screen occurs, thus generating a misconvergence as shown in FIG. 13B. On the other hand, if the movable end “b” is located as illustrated in FIG. 14A, the current i3 is increased by Δi′ while the current i4 is decreased by Δi′. Note that Δi′ is also an increase of the current flowing through the resistor R2 caused by the increased impedance of the winging V2. As a result, the condition of i3<i4 is softened, so that asymmetrical misconvergence between the electron beams of the guns R and B at the upper and lower portions of the fluorescent screen occurs, thus generating a misconvergence as shown in FIG. 14B.

Note that the current Δi′ can also be suppressed by increasing the value of the resistor R2; in this case, however, this substantially decreases the dynamic range of the differential resistor VR2.

FIG. 15 illustrates a first embodiment of the vertical deflection circuit of an inline self convergence type for use in a three-gun color Braun tube according to the present invention. In FIG. 15, an inductor L3 is added to the compensation circuit CP1 of FIG. 4. That is, the inductor L3 is connected in series to the resistor R1 between the movable end “a” of the differential resistor VR1 and a connection point of the windings L1 and L2.

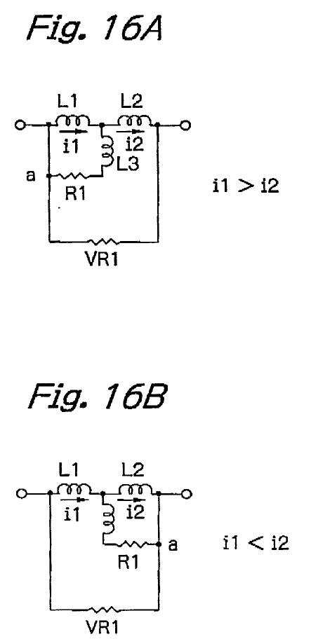

If the movable end “a” is located as illustrated in FIG. 16A, the decrease Δi of the current i1 as shown in FIG. 9B and the increase Δi of the current i2 as shown in FIG. 9C caused by the increased impedance of the winding L1 is compensated for by the increased impedance of the inductor L3. Therefore, the wing-shaped misconvergence as shown in FIG. 10 can be extinguished.

On the other hand, if the movable end “a” is located as illustrated in FIG. 16B, the decrease Δi of the current i1 as shown in FIG. 11B and the increase Δi of the current i2 as shown in FIG. 11C caused by the increased impedance of the winding L2 is compensated for by the increased impedance of the inductor L3. Therefore, the reverse-wing-shaped misconvergence as shown in FIG. 12 disappears.

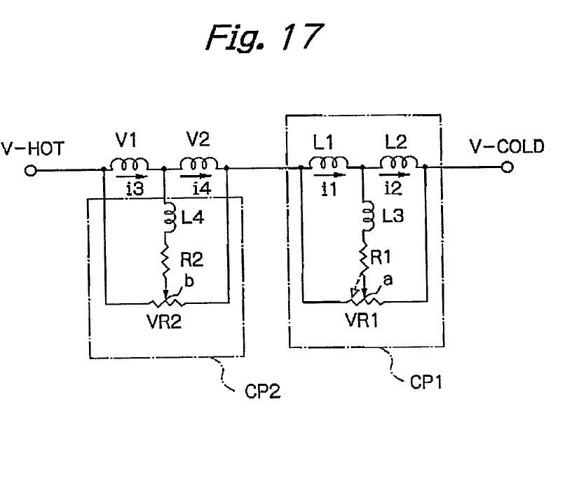

FIG. 17 illustrates a second embodiment of the vertical deflection circuit of an inline self convergence type for use in a three-gun color Braun tube according to the present invention. In FIG. 17, an inductor L4 is added to the compensation circuit CP2 of FIG. 8. That is, the inductor L4 is connected in series to the resistor R2 between the movable end “b” of the differential resistor VR2 and a connection point of the windings L3 and L4.

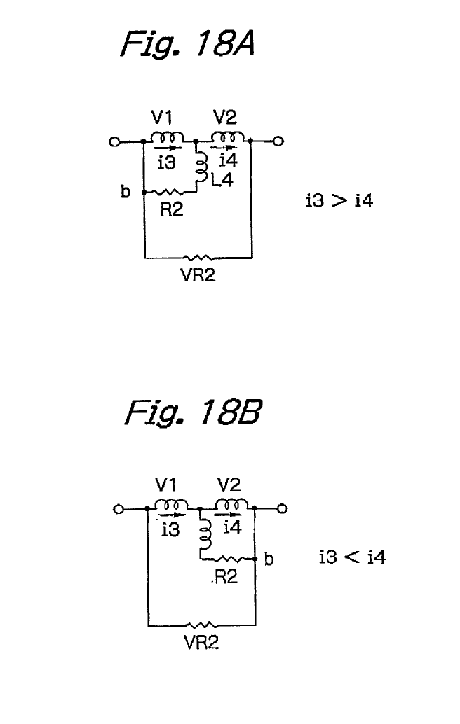

If the movable end “b” is located as illustrated in FIG. 18A, the decrease Δi′ of the current i3 and the increase Δi′ of the current i4 as shown in FIG. 13A caused by the increased impedance of the winding V1 is compensated for by the increased impedance of the inductor L4. Therefore, the wing-shaped misconvergence as shown in FIG. 13B disappears.

On the other hand, if the movable end “b” is located as illustrated in FIG. 18B, the decrease Δi′ of the current i3 and the increase Δi′ of the current i4 as shown in FIG. 14A caused by the increased impedance of the winding V2 is compensated for by the increased impedance of the inductor L4. Therefore, the misconvergence as shown in FIG. 14B disappears.

As explained hereinabove, according to the present invention, since an inductor is provided to compensate for an increased impedance of a first compensation circuit of a vertical deflection circuit, the wing-shaped misconvergence and the reverse-wing-shaped misconvergence disappears. Also, since an inductor is provided to compensate for an increased impedance of the vertical deflection circuit, the misconvergence at the upper and lower portions of a fluorescent screen disappears.

1. An inline self-convergence type deflection yoke for use in a three-gun color Brawn tube, comprising:
a vertical deflection current input terminal;
a vertical deflection current output terminal;
a pair of main vertical deflection windings and a pair of auxiliary vertical deflection windings connected in series between said vertical deflection current input terminal and said vertical current output terminal;
a first differential resistor connected in parallel with the pair of said auxiliary vertical deflection windings and having a first movable end; and
a first inductor connected between said first movable end and a connection point of said auxiliary vertical deflection windings.

2. The inline self-convergence type deflection yoke as set forth in claim 1, further comprising a first resistor connected in series to said first inductor.

3. The inline self-convergence type deflection yoke as set forth in claim 1, further comprising:
a second differential resistor connected in parallel with the pair of said main vertical deflection windings and having a second movable end; and
a second inductor connected between said second movable end and a connection point of said main vertical deflection windings.

4. The inline self-convergence type deflection yoke as set forth in claim 3, further comprising a second resistor connected in series to said second inductor.

5. An inline self-convergence deflection yoke for use in a three-gun color Brawn tube including a neck and three electron guns arranged an X-direction within said neck, comprising:
a pair of horizontal deflection windings arranged oppositely in said X-direction for generating a pin-shaped magnetic field for electron beams emitted from said electron guns;
a pair of main vertical deflection windings arranged oppositely in a Y-direction for generating a barrel-shaped magnetic field for the electron beams emitted from said electron guns;
a pair of auxiliary vertical deflection windings connected in series to said main vertical deflection windings and arranged oppositely in said Y-direction, for generating a pin-shaped magnetic field for the electron beams emitted from said electron guns;
a first differential resistor connected in parallel with the pair of said auxiliary vertical deflection windings and having a first movable end; and
a first inductor connected between said first movable end and a connection point of said auxiliary vertical deflection windings.

6. The inline self-convergence type deflection yoke as set forth in claim 5, further comprising a first resistor connected in series to said first inductor.

7. The inline self-convergence type deflection yoke as set forth in claim 5, further comprising;
a second differential resistor connected in parallel with the pair of said main vertical deflection windings and having a second movable end; and
a second inductor connected between said second movable end and a connection point of said main vertical deflection windings.

8. The inline self-convergence type deflection yoke as set forth in claim 7, further comprising a second resistor connected in series to said second inductor.
